(19) United States
(12) Patent Application Publication
(10) Pub. No.: US 2017/0304967 A1
(43) Pub. Date: Oct. 26, 2017

(54) THREAD REPAIR INSERT

(71) Applicant: Undercar Express, LLC, Cleveland, OH (US)

(72) Inventor: Paul E. Schuck, North Royalton, OH (US)

(73) Assignee: Undercar Express, LLC, Cleveland, OH (US)

(21) Appl. No.: 15/495,139

(22) Filed: Apr. 24, 2017

Related U.S. Application Data
(60) Provisional application No. 62/326,383, filed on Apr. 22, 2016.

(51) Int. Cl. B23P 6/04; F16B 37/12

(52) U.S. Cl. CPC B23P 6/04; F16B 37/122

(57) ABSTRACT

One or more techniques and/or systems are disclosed for a replacement insert, which may be used for replacing stripped threads and providing the new smooth surface for a washer/gasket on component, such as for a vehicle. The insert has an inner and outer threaded surface, and the inner threads are merely partially formed in the inner cavity of the insert, leaving an unthreaded surface proximate the end of the insert. The insert has a shoulder with a greater diameter than the hole into which it is inserted, to stop further insertion. The insert can be threaded into the hole using the thread chaser bit screwed insert, and continued rotation of the chaser past a thread stop can form remaining threads, allowing for application of torque to install the insert in the component.

This application claims priority to a provisional application having Ser. No. 62/326,383, which was filed on Apr. 22, 2016. The provisional application is incorporated herein by reference.

### BACKGROUND

Threaded holes in components, like those found in vehicles, can often exhibit a variety of different failure mechanisms. On occasion, threads for fastening are loaded beyond a tensile strength of the material and the material fractures. In these circumstances, for example, the component material is usually irreparable and should be replaced. Similarly, on occasion, a washer or gasket sealing surface can become corroded, pitted, gouged or otherwise damaged, preventing a smooth surface that is utilized for a strong mechanical connection, which will not leak air and/or fluid. The component with stripped threads is commonly discarded as scrap and replaced with a new one at significant additional expense, as well as creating additional waste in a landfill.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

As provided herein, a system, device and method for replacing or repairing a threaded component, in a low-cost and timely manner, returning the threads and seal surface to a performance level. Such a system, device and method can be used to replace damaged threads and washer/gasket sealing surface in a component part by preparing the damaged site, and replacing the damage with a replacement insert that performs in a similar manner as the component prior to repair.

In one implementation of a device for replacing a threaded portion of a component, a cylindrical body can be dimensioned to fit into a tapped hole in a component; and the cylindrical body can comprise an interior cavity, a first end and a second end. Further, a first thread can be disposed along the outside of the body, between the first end and the second end. Additionally, a second thread can be disposed along a portion of the interior cavity beginning at the first end. A thread stop can also be disposed on the wall of the interior cavity, proximate a second end. The thread stop can mitigate threading of a thread chaser past an end of the second thread.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

What is disclosed herein may take physical form in certain parts and arrangement of parts, and will be described in detail in this specification and illustrated in the accompanying drawings which form a part hereof and wherein:

FIG. 1 is a component diagram illustrating an example implementation of a device for replacing a threaded portion of a component.

FIG. 2 is a component diagram illustrating an example implementation of a device for replacing a threaded portion of a component.

FIG. 3 is a component diagram illustrating an example implementation of a device for replacing a threaded portion of a component.

FIG. 4 is a component diagram illustrating an example implementation of one or more portions of one or more components described herein.

FIG. 5 is a component diagram illustrating a perspective view of example environment where one or more portions of one or more components, described herein, may be implemented.

FIG. 6 is a component diagram illustrating a cut-away view of example environment where one or more portions of one or more components, described herein, may be implemented.

FIG. 7 is a component diagram illustrating a perspective view of example environment where one or more portions of one or more components, described herein, may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices may be shown in block diagram form in order to facilitate describing the claimed subject matter.

A replacement fastener insert system, device and method can be devised to provide a new thread engaging portion, and washer or gasket surface in a component. The device can comprise at threaded insert that is threaded into a drilled and tapped hole in the component, and threaded and press fitted through use of a thread chaser tool. The method and system can comprise drilling and tapping a stripped hole in the component to a size and thread that complements the replacement insert; and inserting the replacement insert into the tapped hole in a threaded and press fit arrangement.

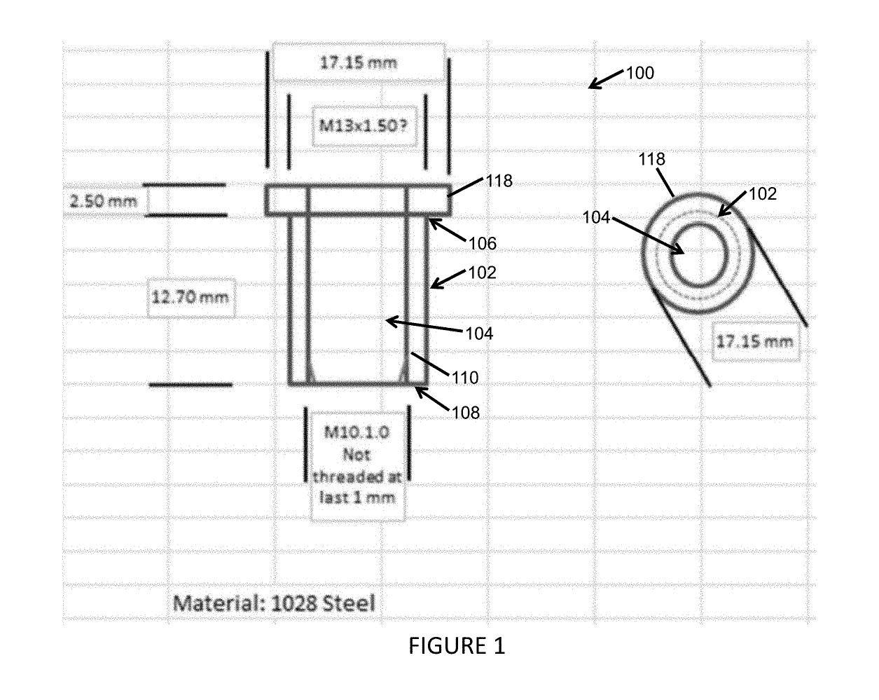

FIGS. 1, 2 and 3 are component diagrams illustrating one or more example implementations of a device 100, 200, 300 for replacing a threaded portion of a component. In one or more implementations, the example device 100, 200, 300 can comprise a cylindrical body 102 that can be dimensioned to fit into a tapped hole in a component. Further, the cylindrical body can comprise an interior cavity 104, a first end 106 and a second end 108. In one or more implementations, a wall 110 between the external portion of the cylindrical body 102 and the interior cavity 104 may comprise a variety of thicknesses, suitably chosen using sound engineering principles.

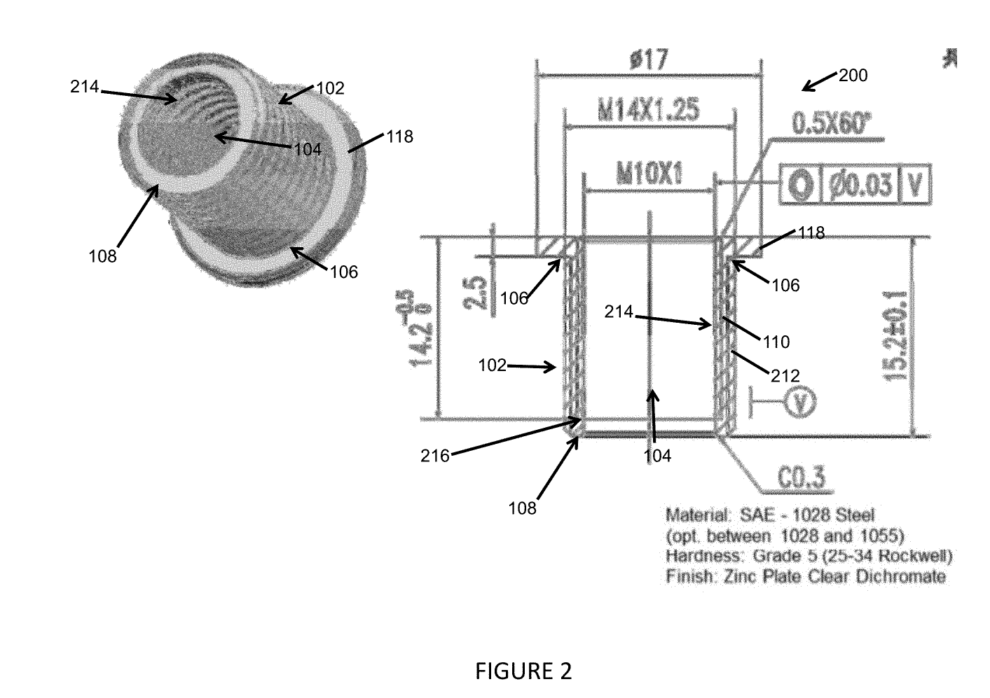

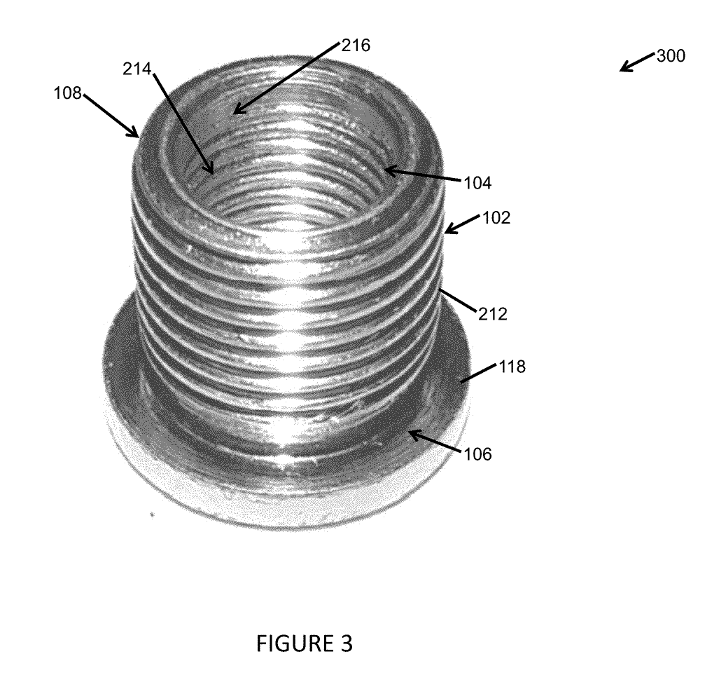

Additionally, the example device 100, 200, 300 can comprise a first thread 212 that is disposed along the outside of the body 102, between the first end 106 and the second end 108. In one implementation, the first thread 212 extends from the first end 106 to the second end 108 along the outside of the body 102. In another implementation, the first thread 212 may extend along merely a portion of the outside of the body 102, between the first end 106 and the second end 108 (e.g., such as starting at the second end 108). As illustrated in FIGS. 2 and 3, the example device 100 can comprise a second thread 214 that is disposed along a portion of the interior cavity 104, beginning at the first end 106. That is, for example, the second thread 214 may be disposed on the interior side of the wall 110, and the first thread 212 may be disposed on the exterior side of the wall 110.

In one implementation, the second thread 214 may merely be disposed on a portion of the interior of the wall 110 (e.g., starting at the first end 106 and ending before the second end 108); in another implementation, the second thread 214 may be disposed along the entirety of the interior of the wall 110. The diameter of the interior cavity 104 and second thread 214 can be so dimensioned to receive the complementary thread chaser (see 406 of FIG. 3) in the second thread 214. In the example implementations, the example device 100, 200, 300 can comprise a thread stop 216 disposed on the wall 110 of the interior cavity 104. The thread stop 216 can be disposed proximate the second end 108, and is configured to mitigate threading of a thread chaser past an end of the second thread 214.

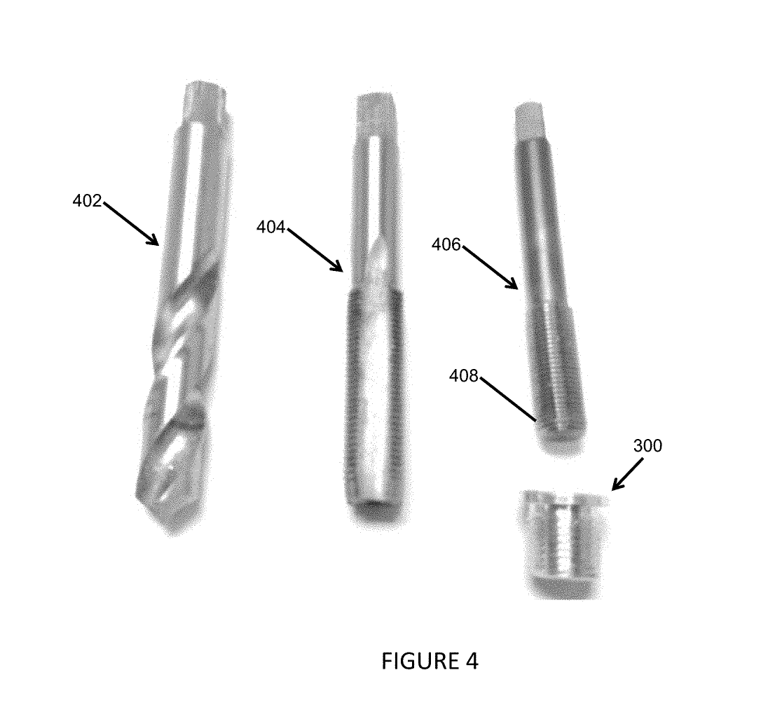

FIG. 4 is a component diagram illustrating one or more portions of one or more systems described herein. In one implementation, when the thread chaser 406 is threadedly engaged with the second thread 214, the thread stop 216 can be configured to stop the thread chaser 406 from continuing the threading past the thread stop 216, under an applied threading force. In this example, the threading force can be a rotational force that is sufficient to thread the example device 100, 200, 300 into the tapped hole in the component. In one implementation, the thread stop 216 may merely comprise an ending of the second thread 214 in the wall 110 (e.g., a valley portion of the thread ends). In another implementation, the thread stop 216 may comprise a formed component that is disposed on the second thread 214 (e.g., at the end).

In one implementation, the thread stop 216 can be configured to allow a continued threading of the thread chaser 406 along the second thread 214 past the thread stop 216 under an applied tapping force. In this implementation, the tapping force can be an applied rotational force that is sufficient to tap the internal cavity 104 past the thread stop 216 in continuation of the second thread 214. That is, for example, the tapping force is greater than the threading force, and the thread chaser 406 can comprise a tapping portion that is configured to tap (e.g., create a thread) in the interior cavity 104 after the thread stop 216. In this example, the second thread 214 is merely disposed on a portion of the wall, and the thread chaser 406 can tap a continuation of the second thread 214 past the thread stop 216 on the interior of the wall 110, under the applied tapping force.

In one implementation, when the tapping force is applied to the thread chaser 406 past the thread stop 216, the diameter of the cylindrical body 102 can expand. In this implementation, this expansion can expand the cylindrical body 102 in the tapped hole under the applied tapping force, which results in a press fit arrangement between the cylindrical body 102 and the component. That is, for example, applying the tapping force can create the continuation of the second thread 214, and expand the example device 100, 200, 300 into the tapped hole, thereby creating a press fit to mitigate loosening of the replacement device in the component.

In one implementation, the example device 100, 200, 300 can comprise a shoulder 118 disposed at the first end 106 of the body 102. In this implementation, the shoulder 118 can comprise a diameter that is larger than a diameter of the body 102 in order to mitigate insertion of the cylindrical body 102 into the tapped hole past the shoulder 118. Further, in one implementation, the shoulder 118 can be configured to mitigate continuation of the applied threading force when the shoulder 118 meets a surface of the component. In this implementation, the threading force is sufficient to merely thread the cylindrical body 102 into the tapped hole.

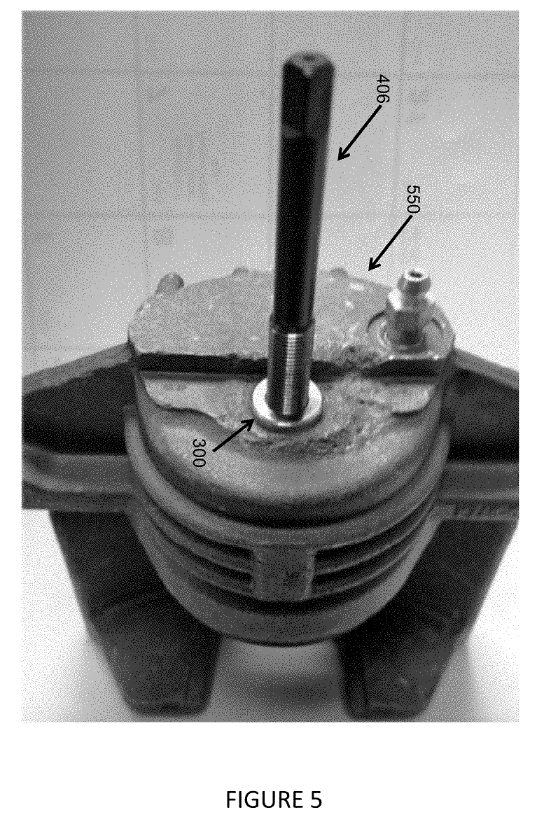

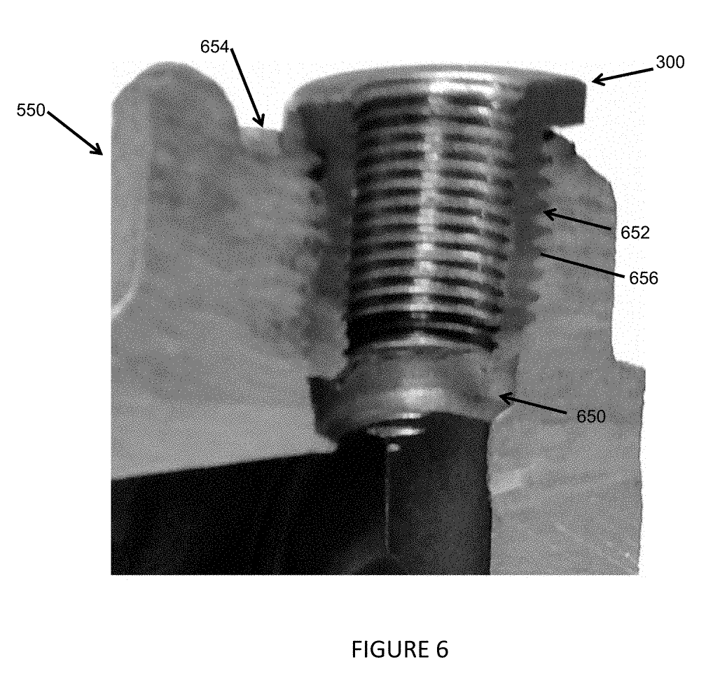

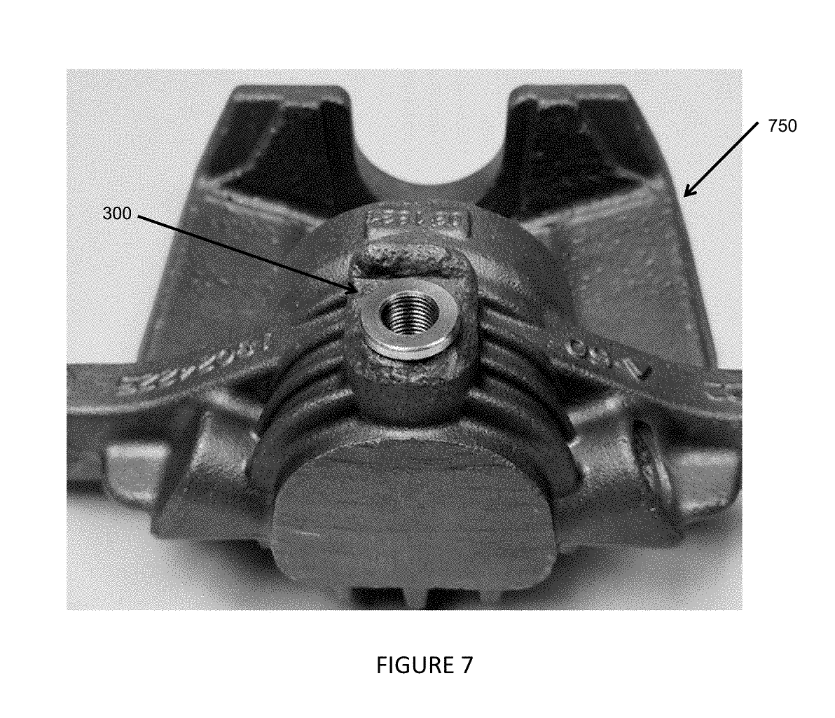

FIGS. 5, 6, and 7 are component diagrams that illustrate example implementations of the devices, systems and methods described herein. In one implementation, the component 550, 750 can comprise a brake caliper. As an example, the brake caliper comprises a threaded hole that is configured to receive a threaded engagement with a brake fluid line (not shown). Occasionally, during use and/or repair, the threaded hole in the caliper may become damaged, and not sufficient for engaging with the brake line. In one implementation, the example device 300 may be used to repair and/or replace the damaged threaded hole in the brake caliper.

With continued reference to FIGS. 1-7, a method may be devised for replacement of damaged threads in a component. In one implementation, the replacement insert 300 can be inserted into the tapped hole 652 in the component 550. In this implementation, inserting the replacement insert 300 can comprise threading the thread chaser 406 onto the second thread 214 that is disposed in the interior cavity 104 of the replacement insert 300 from the first end 106. Further, the thread chaser 406 can be threadedly inserted at least until the thread chaser 406 meets a thread stop 216 that is disposed in the interior cavity 104 proximate the second end 108 of the replacement insert 300. In this implementation, the replacement insert 300 can then be threaded into the tapped hole 652, by threadedly engaging the first threads 212 with the threads of the tapped hole 652.

Additionally, in this example method, the replacement insert 300 can be fixedly engaged into the tapped hole 652. In this implementation, fixing the replacement insert 300 into the tapped hole 652 can comprise continuing to thread the thread chaser 406 into the interior cavity 104 of the replacement insert 300 past the thread stop 216 when the shoulder 118, disposed at the first end 106, meets a surface 654 of the component 550. The continued threading past the thread stop 216 can result in a tapped thread continuing the second thread 214 past the thread stop 216.

In one implementation, the continuing to thread the thread chaser 406 into the interior cavity 104 of the replacement insert 300 past the thread stop 216 can result in an expansion of the second end 108 of the replacement insert 300 in the tapped hole 652. In this implementation, this expansion can provide a press fit arrangement between the replacement insert 300 and the component 550, thereby mitigating undesired displacement of the replacement insert 300 from the component 550.

One implementation of a method for replacement of damaged threads in a component can comprise drilling a hole in the component 550, such as prior to inserting the replacement insert 300. In this implementation, the drilling of the hole can create a hole of sufficient diameter to receive the replacement insert 300, resulting in an existing hole 650. In one example, the component may not have a hole present; and in another example, the component may comprise a damaged (e.g., stripped) hole that is drill to create the existing hole 650. As an example, the existing hole 650 may be drilled using a drill bit 402 of appropriate diameter to accommodate the replacement insert 100.

One implementation of the method can comprise tapping the existing hole 650 in with a receiving thread 656 corresponding to a complementary first thread 212 disposed on an outside of the replacement insert 300, resulting in the tapped hole 652. As an example, the receiving thread 656 may be created in the existing hole 650 using a tap 404 comprising tapping threads appropriate to create the receiving thread 656 in the existing hole. The resulting tapped hole 652 can be configured to receive the first threads 212 of the replacement insert 300 in a threaded engagement, at least until the shoulder 118 meets the surface 654 of the component 550. In one implementation, the example method can comprise applying a thread locking fluid to the first thread 212 prior to inserting the replacement insert 300 in the tapped hole 652. In this way, for example the thread locking fluid may mitigate loosening of the threaded (e.g., and press fit) engagement of the replacement insert 300 with the component 550.

Additionally, the method can comprise applying an installation force that is sufficient to rotate the thread chaser 406 into the interior cavity 104 to threadedly engage the replacement insert 300 with the tapped hole 652 in a clockwise rotation. In this implementation, the installation force can be applied until the shoulder 118 abuts the surface 654 of the component 550, resulting in the replacement insert 300 to cease rotation. Further, in this implementation, a tapping force can be applied to the thread chaser 406. Applying the tapping force can comprise a continued clockwise rotation sufficient to rotate the chaser tip 408 past the thread stop 216, forming a continuation of the second thread 214 using the chaser 406.

In this method, the thread chaser 406 can be removed from the interior cavity 104 after the tapped thread continues the second thread 214 past the thread stop 216. For example, after the thread chaser 406 has created the continued threads in the interior cavity 104 (e.g., and expanded the second end 108), it can be removed, and the newly repaired threads can be used, such as to receive the brake line. In one implementation, the top surface of the shoulder can provide a surface that is sufficient to receive a gasket. For example, a gasket of some type can be used in coupling the replacement insert 300 with a brake line, and the shoulder surface can be relatively smooth to effectively receive the gasket.

Further, the threaded replacement fastener insert can be installed in the tapped hole. The replacement fastener insert can comprise a hollow cylindrical body, with an internal and external thread pattern. The external thread pattern (e.g., first thread pattern) can be comprised on the length of the exterior of the body. The insert can comprise a shoulder at a first end of the body, with a washer/gasket surface that is similar to, or better than, that of target component. Additionally, the internal thread pattern (e.g., second thread pattern) may merely be comprised on a portion of the interior of the body, starting at the first end, and running to a thread stop proximate a second end of the body (e.g., opposite the first end). As an example, the thread stop can comprise the interior wall of the body, absent a thread pattern (e.g., one to two thread turns near the bottom of the body). In this example, the end of the internal threads can provide a stop for a threading action of another component into the internal portion of the body.

In one implementation, a replacement fastener insert can be used for replacing stripped threads and providing the new smooth surface for a washer/gasket on vehicle component. The insert can comprise both an inner threaded surfaces and an outer threaded surfaces. Inner threads may not be fully formed at the last one to two threads of insert, send end (e.g., non-shoulder end). A thread chaser bit can be utilized in the interior of same diameter and thread pitch to facilitate installation of the insert fully into the component, and to mitigate marring of other surfaces. The insert can comprise a shoulder, at a first end, which has a greater diameter than the diameter of the interior and equal to or larger than a washer/gasket, which may be used for sealing. The insert is threaded into a tapped hole in the component, using the thread chaser bit screwed into the first (e.g., shoulder) end of the insert. Rotation of the chaser in the insert is mitigated at a stop formed by the missing 1-2 threads, which allows for application of torque to install the insert in the component, further stopped by the shoulder abutting against a component surface. Upon further clockwise rotation of the thread chaser, the stop formed by the missing threads can be converted into threads by continued rotation of the chaser. Further, the outer diameter of that same area of the insert expands slightly to support retention of the insert in the component hole.

Another further object of the present invention is to provide a method of installing the replacement fastener insert fully without marring other insert surfaces.

Another further object is to provide additional tensile strength of the component threads in aluminum.

In the designed form, the parts of this system can include the threaded insert, disclosed herein, which provides full threads on the outside shank of the insert.

In one aspect, a replacement fastener insert is provided with threads on a portion of the inside surface, with the threads not fully formed at the second end of the insert. For example, one to two thread turns may be missing from the second end (e.g., at opposite end of shoulder) to serve as a stop element to use a thread chaser as the installation device.

In a further aspect of the form, a fastener insert is provided with a shoulder to abut fully against surface being repaired and a smooth surface for washer/gasket seal.

Another feature and advantage of the invention includes additional thread tensile strength of internal threads when used in an aluminum component.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Of course, those skilled in the art will recognize many modifications may be made to this configuration without departing from the scope or spirit of the claimed subject matter.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

What is claimed is:

1. A device for replacing a threaded portion of a component, comprising:
a cylindrical body dimensioned to fit into a tapped hole in a component, and comprising an interior cavity, a first end and a second end;
a first thread disposed along the outside of the body between the first end and the second end;
a second thread disposed along a portion of the interior cavity beginning at the first end; and
a thread stop disposed on the wall of the interior cavity, proximate a second end, to mitigate threading of a thread chaser past an end of the second thread.

2. The device of claim 1, comprising a shoulder disposed at the first end of the body, the shoulder comprising a diameter larger than a diameter of the body to mitigate insertion of the cylindrical body into the tapped hole past the shoulder.

3. The device of claim 2, the shoulder configured to mitigate an applied threading force when the shoulder meets a surface of the component, the threading force sufficient to thread the cylindrical body into the tapped hole.

4. The device of claim 1, the thread stop comprising the end of the second thread on the wall of the interior cavity.

5. The device of claim 1, the diameter of the interior cavity and second thread so dimensioned to receive a complementary thread chaser in the second thread.

6. The device of claim 1, the thread stop able to mitigate threading of the thread chaser along the second thread under an applied threading force, the threading force sufficient to thread the cylindrical body into the tapped hole.

7. The device of claim 1, the thread stop allowing continued threading of the thread chaser along the second thread past the thread stop under an applied tapping force, the tapping force sufficient to tap the internal cavity past the thread stop in continuation of the second thread.

8. The device of claim 7, the diameter of cylindrical body expanding in the tapped hole under the applied tapping force, resulting in a press fit arrangement between the cylindrical body and the component.

9. The device of claim 1, the cylindrical body dimensioned to fit into a brake caliper fitting hole that has been drill and tapped to receive the cylindrical body.

10. A method for replacement of damaged threads in a component, comprising:
inserting a replacement insert in a tapped hole in a component, comprising threading a thread chaser onto a second thread disposed in an interior cavity of the replacement insert at a first end, at least until the thread chaser meets a thread stop disposed in the interior cavity proximate a second end of the replacement insert, and threading the replacement insert into the tapped hole; and
fixing the replacement insert into the tapped hole comprising, upon a shoulder disposed at the first end of the replacement insert meeting a surface of the component, continuing to thread the thread chaser into the interior cavity of the replacement insert past the thread stop, resulting in a tapped thread continuing the second thread past the thread stop.

11. The method of claim 1, the continuing to thread the thread chaser into the interior cavity of the replacement insert past the thread stop resulting in an expansion of the second end of the replacement insert in the tapped hole providing a press fit arrangement between the replacement insert and the component.

12. The method of claim 10, comprising drilling a hole in the component of sufficient diameter to receive the replacement insert, resulting in an existing hole.

13. The method of claim 12, drilling a hole in the component comprising drilling out an existing stripped hole, that has an existing stripped thread.

14. The method of claim 13, comprising tapping the existing hole in with a receiving thread corresponding to a complementary first thread disposed on an outside of the replacement insert, resulting in the tapped hole.

15. The method of claim 14, comprising applying a thread locking fluid to the first thread prior to inserting the replacement insert in the tapped hole.

16. The method of claim 10, comprising removing the thread chaser from the interior cavity after the tapped thread continues the second thread past the thread stop.

17. The method of claim 10, inserting the replacement insert in the tapped hole comprising:
applying an installation force sufficient to rotate the thread chaser into the interior cavity to threadedly engage the replacement insert with the tapped hole in a clockwise rotation until the shoulder abuts the surface of the component, resulting in the replacement insert to cease rotation;
applying a tapping force to the thread chaser comprising a continued clockwise rotation sufficient to rotate the chaser tip past the thread stop, forming a continuation of the second thread using the chaser.

18. A system used to replace stripped threads in a component, comprising:
a drilling component for drilling a hole in a component, resulting in a drilled hole comprising a sufficient size to receive a replacement component;
a tapping component for tapping the drilled hole resulting in a tapped hole comprising a thread that is complementary to a first thread disposed on an external surface of the replacement component;
a thread chaser component that is used to thread the replacement component into the tapped hole and tap at least a portion of a second thread disposed on an internal surface of the replacement component;
the replacement component comprising:
a cylindrical body comprising the external first thread, a first end and a second end;
an internal cavity comprising the internal second thread that receives the thread chaser in a threaded engagement;
a shoulder disposed at the first end of the cylindrical body comprising a diameter greater than a diameter of the cylindrical body to mitigate threading of the replacement component into the tapped hole past the shoulder;
a thread stop disposed in the internal cavity proximate the second end that mitigates threading of the thread chaser past the thread stop under a threading force, and allows tapping of the internal cavity past the thread stop under a tapping force that is greater than the threading force.

19. The system of claim 18, the second end of the cylindrical body expanding under the tapping force, resulting in a press fit arrangement between the replacement component and the component.

20. The system of claim 18, the shoulder providing a desired surface sufficient to receive a gasket.
